(19) United States
(12) Patent Application Publication
(10) Pub. No.: US 2002/0103557 A1
(43) Pub. Date: Aug. 1, 2002

(54) Design tool systems and methods, and user interface

(75) Inventor: Richard J. Land, Gainesville, GA (US)

Correspondence Address: HINKLE & O'BRADOVICH, LLC, 395 SCENIC HIGHWAY, LAWERENCEVILLE, GA, 30045, US

(73) Assignee: Habersham Metal Products Company, Cornelia, GA

(21) Appl. No.: 09/970,206

(22) Filed: Oct. 3, 2001

Related U.S. Application Data
(60) Provisional application No. 60/237,895, filed on Oct. 4, 2000.

(51) Int. Cl. G06F 19/00; G06F 15/16; G09G 5/00; G06K 1/18; B23P 11/00

(52) U.S. Cl. 700/96; 700/97; 700/106; 700/180; 709/203; 345/764; 345/751; 345/964; 234/13; 29/432

(57) ABSTRACT

A method and apparatus for inputting design specifications to calculate output specifications and manufacturing machine code is disclosed. A user interface simplifies the data input by a user to calculate the necessary manufacturing specifications. The user interface is typically connected to a computer aided design (CAD) process. The CAD process in turn processes the design input specifications entered by the user.

### CROSS-REFERENCE TO RELATED APPLICATIONS

This application claims the priority benefit of U.S. Provisional Patent Application No. 60/237,895 filed Oct. 4, 2000, entitled “Process Control”.

### BACKGROUND OF THE INVENTION

1. Field of the Invention

The present invention relates generally to the field of manufacturing, and more particularly to a method and apparatus for controlling large scale manufacturing machines.

2. Description of the Related Art

Computer aided design (CAD) processes are used commonly to calculate manufacturing and architectural specifications in many manufacturing industries. Computer aided design processes are typically complicated and require a vast knowledge base in order to properly calculate the specifications. Acquiring this knowledge base is time consuming and burdensome to most manufacturers. Furthermore, manual entry of the manufacturing and architectural specifications can take a large amount of time that can slow down the manufacturing process. In addition, it creates a large amount of inertia in the response time to respond to offers to make bids in a manufacturing process.

### SUMMARY OF THE INVENTION

In accordance with the present invention and the contemplated problems which have and continue to exist in this field, the invention features a method and apparatus for entering design specifications to calculate output specifications and manufacturing machine code for CAD processes.

In general in one aspect, the invention features a manufacturing control system, including at least one server adapted to process specification data, at least one client connected to the server, the client having specification data, a design process residing on the server, a user interface residing on the client and a translation process connected between the client and the server.

In one implementation, the system includes at least one information database.

In another implementation, the informational database includes hollow metal manufacturing data.

In another implementation, the specification input user interface includes fields for hollow metal manufacturing input.

In another implementation, the system is connected to a network.

In another implementation, the system further includes a manufacturing machines adapted to receive processed specification data from the server.

In another aspect, the invention features a manufacturing control method, including defining an article of manufacture on a user interface, creating data files from the user interface, creating batch files from the data files, transferring the data files to a design process, processing the batch files and generating output.

In one implementation, the article of manufacture relates to hollow metal.

In another implementation, the data files are tags.

In another implementation, the batch files are a collection of tags.

In another implementation, the design process is computer aided design software.

In still another implementation, the output includes drawings.

In another implementation, the output includes data files.

In another implementation, the output includes numerical control code.

In still another implementation, the files are transferred to a server over a network.

In yet another implementation, the files are processed by a computer aided design process on the server.

In another aspect, the invention features a user interface, including a customer information screen, a job information screen, a job details screen, data screens adapted to receive manufacturing specification data, and an operational screen adapted to allow a user to navigate between the customer information, job information, job details and data screens.

In one implementation, the job information screen includes a scheduling screen, a shipping information screen, a change order information screen and a pricing information screen, wherein the scheduling, shipping, change order information and pricing information screens are adapted to be navigated from the job information screen.

In another implementation, the data screens include a buck and mull design screen.

In another implementation, the data screens include a door design screen.

In still another implementation, the data screens include a frame design screen.

In yet another implementation, the data screens include a hardware screen.

In another implementation, the data screens include a tag design screen, wherein the tag defines a article of manufacture design.

In still another aspect, the invention features a method of interfacing to computer aided design software, including generating a user interface adapted to receive manufacturing specifications, connecting the user interface to a translation process, using the translation process to adapt the manufacturing specifications to data readable by a computer aided design process, connecting the translation process to a pipe adapted to interface with the computer aided design process and using the computer aided design process to generate output based on the translated manufacturing specifications data.

In yet another aspect, the invention features a computer program residing on a computer readable medium comprising instructions for causing a computer to generate a user interface adapted to receive manufacturing specifications, connect the user interface to a translation process, use the translation process to adapt the manufacturing specifications to data readable by a computer aided design process, connect the translation process to a pipe adapted to interface with the computer aided design process and use the computer aided design process to generate output based on the translated manufacturing specifications data.

In another aspect, the invention features a method of generating CAD data, including entering manufacturing specifications data into a user interface, organizing the manufacturing specifications data to tags, organizing the tags into batch files adapted to be translated into CAD usable data and preparing the batches to be transferred to a translation process.

In another aspect, the invention features a method of implementing a CAD process, including receiving manufacturing specification data organized into batches into a translation process residing on a server, using the translation process to translate the manufacturing specification data to CAD usable data, entering the CAD usable data into a CAD process and using the CAD process to generate output based on the CAD usable data.

In another aspect, the invention features a process for developing hollow metal products, the process comprising a user interface adapted to receive specifications for the products, a design process connected to the user interface, the design process adapted to receive data from the user interface and a punch machine process connected to the design process, the punch machine process adapted to control hollow metal manufacturing machines that form hollow metal into the hollow metal products.

One advantage of the invention is that it reduces the large number of steps needed to calculate the manufacturing specifications in many manufacturing processes.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates a manufacturing control system;

FIG. 2 illustrates a system flow diagram of an embodiment of a manufacturing system;

FIG. 3 illustrates an embodiment of an output process;

FIG. 4 illustrates a flow chart of an implementation of a manufacturing process;

FIG. 5 illustrates an embodiment of a data grid;

FIG. 6 illustrates an embodiment of a main menu screen;

FIG. 7 illustrates an embodiment of a customer information screen;

FIG. 8 illustrates an embodiment of a job/contract screen having six tabs leading to informational screens;

FIG. 9 illustrates an embodiment of a job details screen;

FIG. 10 illustrates an embodiment of a buck design screen;

FIG. 11 illustrates an embodiment of a hardware set screen;

FIG. 12 illustrates an embodiment of an edit hardware sets screen;

FIG. 13 illustrates an embodiment of a hardware search screen;

FIG. 14 illustrates an embodiment of a Frame Glass Stop screen;

FIG. 15 illustrates an embodiment of a Door Glass Stop screen;

FIG. 16 illustrates an embodiment of a Questions screen;

FIG. 17 illustrates an embodiment of a Master Job Specifications screen;

FIG. 18 illustrates an embodiment of an add tags screen 1800;

FIG. 19 illustrates an embodiment of a tag detail screen 1900;

FIG. 20 illustrates an embodiment of a hand selection screen;

FIG. 21 illustrates an embodiment of a frame information screen;

FIG. 22 illustrates an embodiment of a frame design data grid screen;

FIG. 23 illustrates an embodiment of a door information screen;

FIG. 24 illustrates an embodiment of a door design screen;

FIG. 25 illustrates an embodiment of a locate hardware screen;

FIG. 26 illustrates an embodiment of a release screen;

FIG. 27 illustrates an embodiment of a batch creation screen 2700;

FIG. 28 illustrates an embodiment of a prep cuts screen 2800; and

FIG. 29 illustrates an embodiment of a server processor status screen 2900.

### DETAILED DESCRIPTION OF THE INVENTION

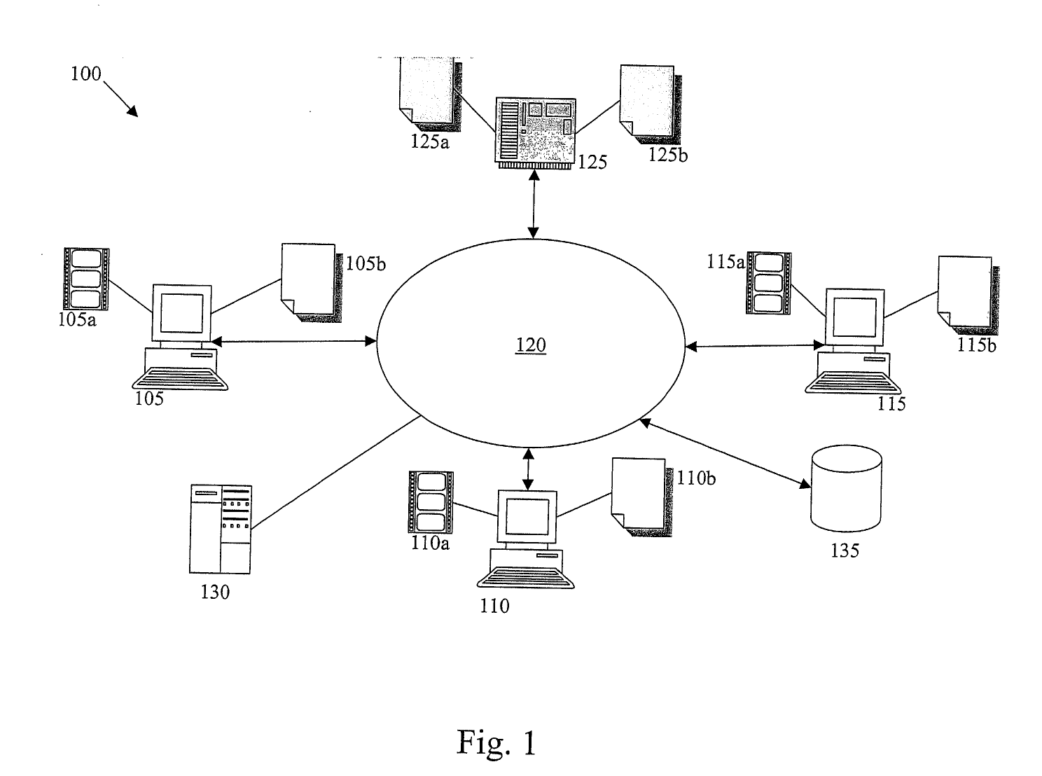

Referring to the drawings wherein like reference numerals designate corresponding parts throughout the several figures, reference is made first to FIG. 1 that illustrates a manufacturing control system 100. The system 100 includes several workstations 105, 110, 115 on a network 120. The network can be any network such as the Internet, smaller wide area networks (WANs), local area networks (LANs) or other types of networks. A server 125 is also connected to the network 120. Manufacturing machines 130 can also be connected to the network 120. The system 100 typically includes one or more informational databases such as database 135 to store information useful for CAD processes. In an implementation, the system 100 is used for hollow metal manufacturing and the database 135 can include information related to hollow metal manufacturing such as hardware, buck and mull designs, door and frame designs and the like.

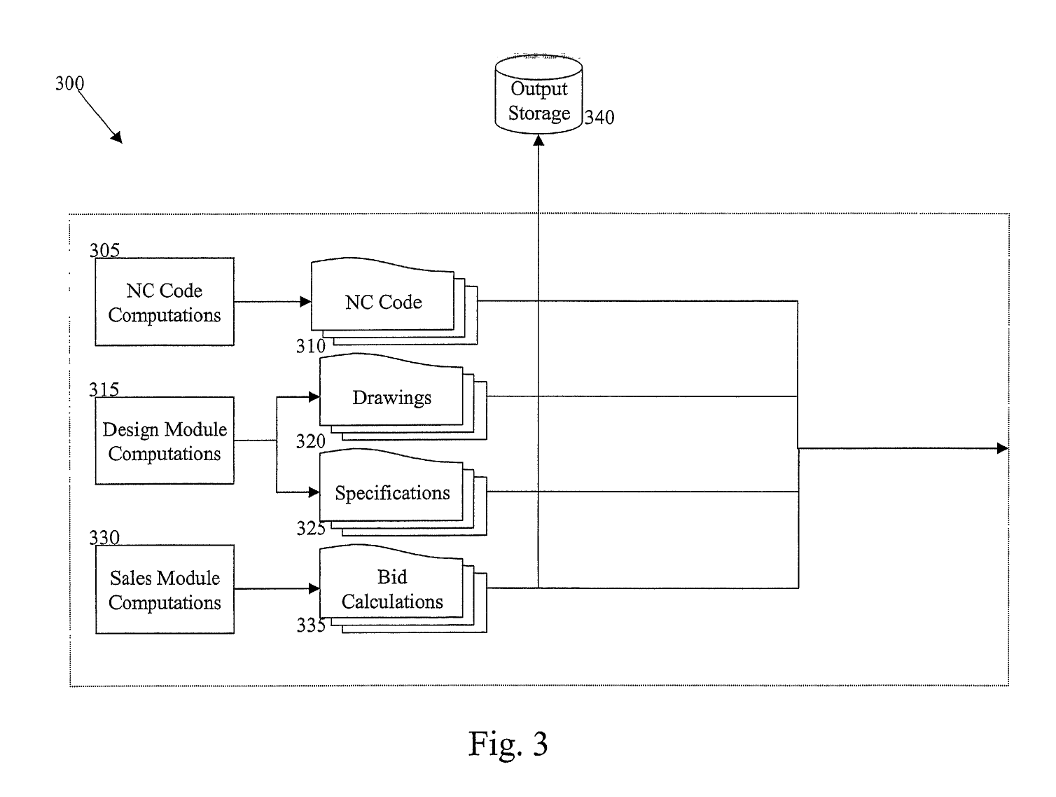

One or more of the workstations 105, 110,115 can include a process 105a, 110a, 115a for entering manufacturing specifications. The process 105a, 110a, 115a is used to generate a user interface 105b, 110b, 115b that allows a user of the system 100 to easily input manufacturing specifications. The types of manufacturing specifications are described in more detail below with respect to FIG. 3. In a typical embodiment, the manufacturing specifications relate to hollow metal manufacturing for window, door and steel prison cells. It is understood that manufacturing specifications for various other types of industries can be created with the system 100. By having the ability to input manufacturing specifications, a user of the system 100 can easily interface with a CAD design process as described in more detail below. For example, a user of the system can receive an architect design that calls for several different hollow metal doors and frames. The specifics, such as dimensions, hardware and the like can be input by the user using the system 100. As described above, any user from any of the workstations 105, 110, 115 can input the manufacturing specifications.

The workstations 105, 110, 115 can connect to the server 125 once the user has input the specifications. The specifications are then downloaded to the server 125 for processing. The server 125 can include a translation process 125a that is used to process the specifications for use with a CAD design process 125b. The design process 125b, such as a CAD software package (e.g. ProEngineer, or any other commercially available or proprietary design package) is used to create manufacturers drawings, numerical control (nc) code, further design specifications, bid calculations and the like. The translation process 125a takes the user input and translates it to input data usable by the design process 125b. Using the system 100, the user is able to easily input simple manufacturing specifications and requirements, such as from an architects plans. More importantly, the user does not have to be concerned with neither the complexities of the input data usually required by a CAD design processes such as process 125b, nor the complexities of translating CAD output to useable drawings, machine nc code and the like.

Typically one or more servers can be used in the system 100. Any individual server like server 125 reads a data table that includes all of the clients on the network 120. The data table indicates whether there is any data to process. If there is data to process, the server 125 sees if there is another server servicing the data. IF not, the server 125 processes that data. In this way, the efficiency of the system 100 can be increased by maximizing data servicing.

### Manufacturing Process

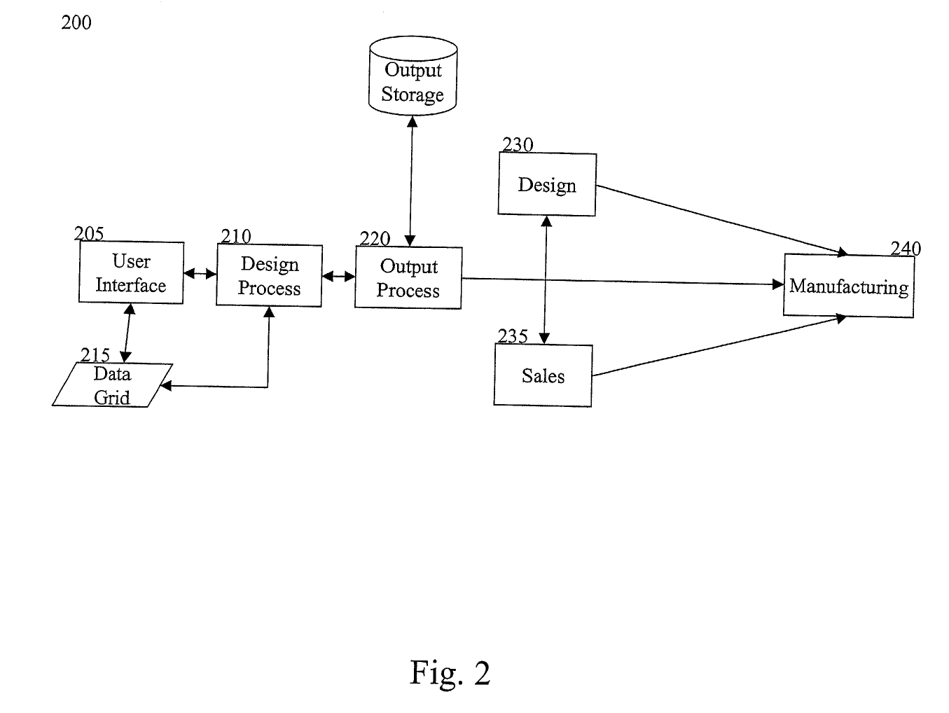

FIG. 2 illustrates an implementation of system flow diagram 200 of an embodiment of a manufacturing system. A user interface 205 (as described above with respect to FIG. 1) is used to input data extracted from design specifications into a design process 210 (such as a CAD program as described above with respect to FIG. 1). Several embodiments of the user interface 205 are described in detail below. As described above, the design process 210 is typically a CAD design process that creates detailed output files used for manufacturing design considerations and bidding procedures.

The design process 210 is connected to a data grid 215. The data grid 215 typically is the fundamental building block from which virtually any design entered through the user interface 205 can be created. The data grid 215 is adapted to receive specifications from the design process 210 and transform them into specific data needed by an output process 220 to control manufacturing machinery, make sales bids, create drawings and other related manufacturing processes.

The data 215 grid is then used to output the proper specifications and data files to the output process. The design process 210 is also connected to the output process 220 that can be used to store the output data to an output storage device 225. The output process 220 also outputs data to a design module 230, a sales module 235 and a manufacturing module 240. The output process can create useful outputs for the user such as detailed drawings, data files, machine nc code and other data used in the manufacturing, sales and marketing processes.

The design module 230 is used to receive the technical specifications. The design module 230 can be used to make modifications to the original specifications input through the user interface 205. The design module 230 typically includes user input.

The sales module 235 can analyze the specifications for making bids and other types of offers and counter offers in response to the original specifications. The sales module 235 can be used for a variety of other purposes such as sending back the output data to the design module or the design process to recalculate the output data for changes in the original bid or original specifications.

The manufacturing module 240 is the process that creates the physical article that the original design and specifications were created to manufacture. Computer code is generated by the design process and the design module that ultimately controls the manufacturing equipment used in the manufacturing module.

FIG. 3 illustrates an embodiment of an output process 300. The output process 300 contains much of the data used in the modules as described with respect to FIG. 2. NC code computations 305 are partially calculated by the design process to create actual NC code 310 ultimately usable by the manufacturing machines and the NC code 310 can be output to the manufacturing module. Design module computations 315 are also created by the design process and can include drawings 320 and specifications 325 computed by the design process and to be analyzed by the design module with user input. The output can also include sales module computations 330 translated into bid calculations 335 that is output to the sales module for sales and bid analysis. Any output can be stored in an output storage database 340.

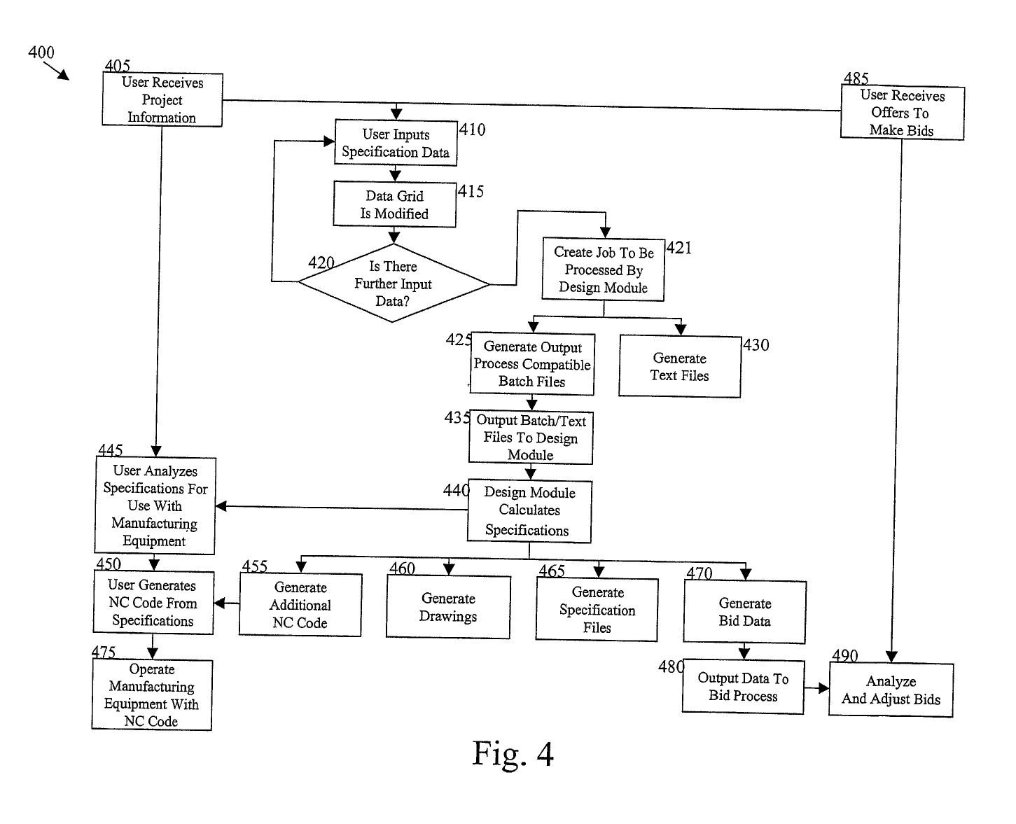

FIG. 4 illustrates a flow chart of an implementation of a manufacturing process 400. The process 400 is a general overview of the process that implements the user interface as described further below. Typically, a user of the manufacturing process receives project information 405 and one or more offers to makes bids 485 for that project. The job information can be in the form of architect's plans, manufacturing specifications and the like. Offers to make bids typically accompany the project so that the manufacturer can generate a bid based on the project. The user then inputs 410 the specification data that is typically included with the project into the manufacturing process. The specification data related to hollow metal manufacturing typically includes, the types of doors, door frames, window frames hardware and the like, that is needed for the project. Typically, as the specifications are input, the data grid is modified (described further below) 415. If there is no further data to input 420, then jobs are created 421 to be processed by the design module. Jobs typically include tags (described in detail below). Batch files are generated 425 for the output process as well as data files 430. The data files can include formats that are usable by the design process. The batch/data files are output 435 to the design module The design module calculates or otherwise modifies the appropriate specifications 440. As described above, the design module resides on the server machine which processes the batch files. Such calculations and/or modifications are typically necessary for compatibility with the design module. In this way, the simple user data that is input in the user interface is translated into design module-compatible data.

The user analyzes 445 the specifications for use with the manufacturing equipment and modifies the information if necessary. Analysis by the user is important to ensure that the specifications and NC code are correct for the project. The user generates 450 NC code from the specifications and uses any NC code generated from the design process. The NC code can then be used to operate the manufacturing equipment. Data files drawings, further specification files 465 and bid data 470 are also calculated by the output modules. The drawings can be used during the manufacturing process along with the architect plans. The bid data is output 480 to the sales process where the bids can be analyzed and adjusted 490 accordingly.

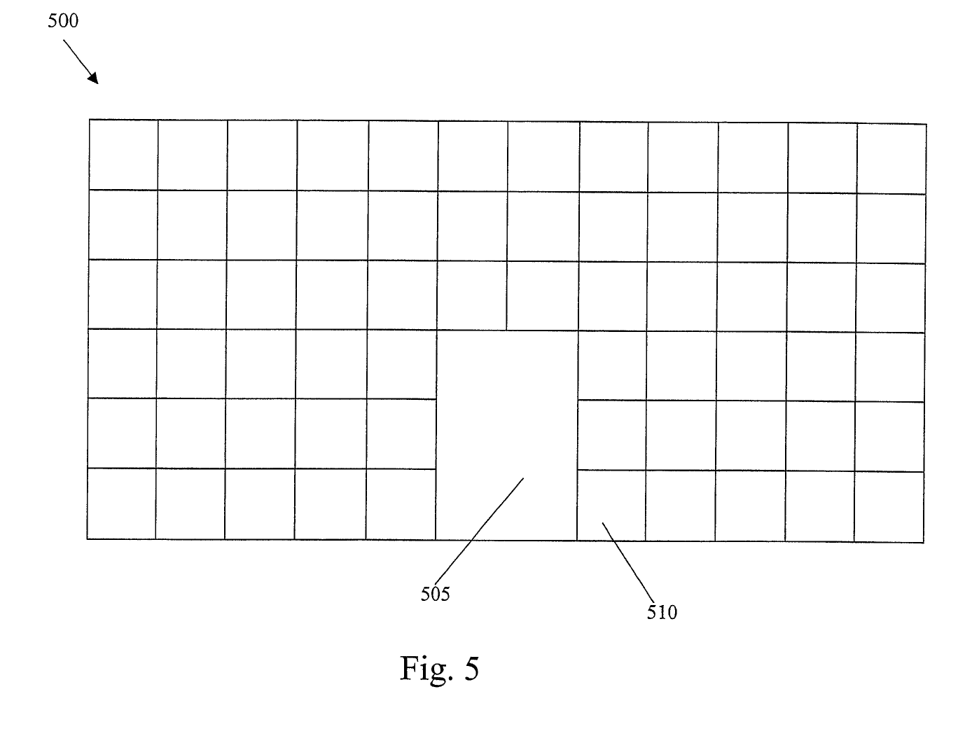

FIG. 5 illustrates an embodiment of a data grid 500. The data grid 500 is the basic data structure used to design the doors, door frames, window frames and the like needed in a project. Many different software processes and data structures can be used to generate the data grid. The design module is appropriately interfaced with the data grid to create the designs. Various other cells such as cell 510 can be used to generate designs for side lights and other windows for the door. In another implementation, the data grid 500 can be used to generate window frame designs. The data grid 500 is described in greater detail below with respect to the user interface.

### The User Interface

The descriptions above of the manufacturing system and process referred several times to a user interface. The user interface is used to simplify the steps necessary to use designs, processes and modules such as the CAD package, ProEngineer. Doors and frames can be designed intuitively without complex CAD interaction. All design and intent is handled through the user interface with basic dimensions, prompts, specifications, hardware identifications and locations. Once the user completes the doors and frames for a project, the job is sent to the server to be processed. The server runs the design module unattended and builds frames and door models based on the user input.

In general, for hollow metal manufacturing, the user interface is utilized to exploit as “master” frame/door model. The model contains all information necessary to make all possible frame and door assemblies from the user interface. Parameters can be turned on and off in the user interface to attain the desired design. The model also contains all the necessary hardware items. Typically, keeping track of the hardware in the database is an ongoing process, requiring this master model to be constantly updated. The output generated by the user interface, such as database files, drive the master model. The output contains information that populates the master model. The interconnection between the output process and the design process allows the CAD program, for example, to read the output and correspondingly create the necessary specifications. In an implementation, the database files contain the data that is passed to the master model to build the desired model.

The discussion now turns to a description of the user interface and software used to interface with the design module.

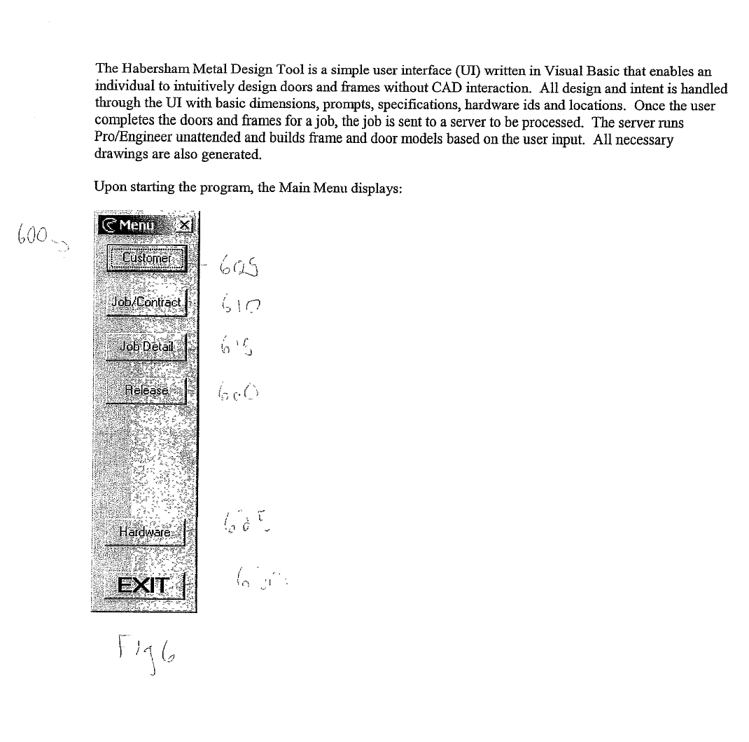

FIG. 6 illustrates an embodiment of a main menu screen 600. The menu screen 600 can include several buttons to navigate a user to several different interface screens. The buttons can include a customer button 605 that navigates the user to a customer information screen. The customer is typically the entity who supplies the project information and to whom bids are directed.

The screen 600 can also include a job/contract button 610 that navigates the user to a series of screens containing information including scheduling, shipping, order changes, job-related information, pricing and owner/architect information. These screens can be useful in keeping track of key dates such as receipt of letter of intent, purchase order, set of plans and shop drawings. Other important features can include alerting the user if partial or full shipments are being sent after a job is processed and keeping track of bid parameters.

The screen can further include a job detail button 615 that navigates the user to a series of screens that are used to enter the details of the job. In an embodiment, as described above, the user interface can be used for hollow metal manufacturing. In the embodiment, the job details screens includes fields and buttons that receive data related to hollow metal manufacturing, such as bucks and mulls design, hardware set criteria, door design frame design and the like.

The screen 600 can further include a release button 625 that is used to “release” the project to be processed by the server.

The screen 600 can further include a hardware button 625 that navigates the user to a hardware screen in which hardware sets for projects can be added, modified or deleted as needed. The screen to which the user is navigated is similar to the screen described with respect to the job detail button 615.

Finally, the screen 600 can include an exit button 630 which takes the user out of the interface and exits the software.

The screens described previously are now discussed in further detail.

Customer

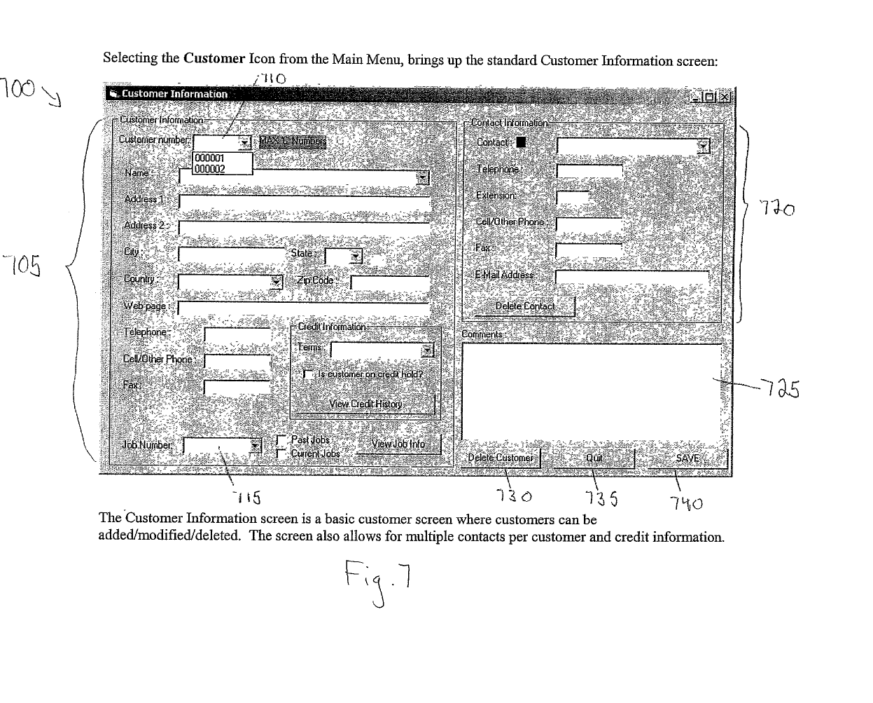

When the user presses the customer button 605, the user is navigated to a series of screens related to customer information. Each job has a customer associated with it. In order to associate a customer with the job to be designed by the customer module, the user interface includes a screen to input customer information and associate the information with a job. FIG. 7 illustrates an embodiment of a customer information screen 700. The customer information screen 700 is a basic screen where customer can be added modified or deleted. The screen 700 can include a customer information section 705 having standard data fields such as but not limited to name, address, city, state, zip code, telephone/facsimile numbers, credit information, job information and history and the like. The customer can be uniquely identified by a customer number field 710. In this way, all customer information can be pulled up by the use of a single number. Furthermore, each job for a customer can be uniquely identified by a job number field 715. Entire jobs and all of the detailed information associated with that job can be recalled by a single number in the job number field 715.

The screen 700 can further include contact information section 720 that can have several data fields including but not limited to a contact name, telephone/facsimile numbers, e-mail address and the like. A comment field 725 can be included for data not covered by the fields described above.

A delete customer button 730 can be used to delete all of the customer information in the screen 700. The user can also press a quit button 735 to leave the screen 700. Finally, if any new customer information has been added or old customer information has been modified a save button 740 can be used to save that information.

Job/Contract

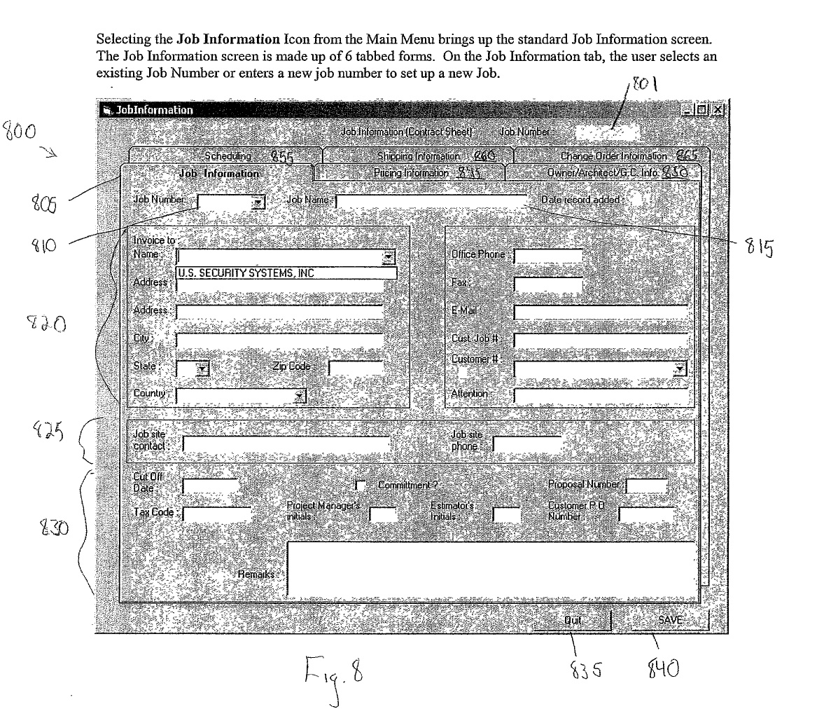

Referring again to FIG. 6, if the user presses the job/contract button 610 from the main menu 600, the user is navigated to a series of screens related to the job and contract associated with that job. FIG. 8 illustrates an embodiment of a job/contract screen 800 having six tabs leading to informational screens. A job number field 801 is present no matter which tab the user chooses.

Typically when the job/contract button from the main menu is pressed, the user is navigated to the job information tab 805 as a default screen. The job information tab 805 typically includes a job number field, similar to the job number field described above with respect to the customer information screen (FIG. 7). As described, the job number can be entered to uniquely identify the job information. A job name field 815 can be used to name the job. An invoice section 820 can contain fields for invoicing information including but not limited to name, address, city state, zip code, county telephone/facsimile numbers, job number customer number and any attention contact. Since the job site for a particular job may often differ from the contact information, a job site information section 825 can be included in the job information tab 805. The job site section 825 can include a field for a contact person at the site and a job site telephone number. The tab 805 can include other pertinent fields in the remaining section 830 of the tab 805 such as, but not limited to a cutoff date, tax code customer PO (purchase order) number and a field for remarks. The screen 800 can further include a quit button to leave the job information screen 800 and a save button 840 to save any new or modified information in any of the tabs.

The user can click on any of the remaining tabs 845, 850, 855, 860, 865. The pricing information tab typically includes the total number of frames (door and window) and doors for the job, the price per frame and door, total price, freight price, number of loads and number of openings. The total contract price, any price adjustments and total price is included in the tab 845. The tab 845 can also indicate whether or not any drill and tap holes are to be included and the cost associated with the holes.

The Owner/Architect and G.C. (general contractor) info tab 850 typically includes a title designation field (i.e. owner, architect or general contractor), and a general informational section having fields including but not limited to name, address, city, state, zip code, country, telephone/facsimile numbers, email address and the like.

The scheduling tab 855 typically includes pertinent fields for dates such as but not limited to, when the plans were received, the date the template was received, when the plans were released for fabrication, when shop drawings were submitted and received, date history and the like. The tab 855 also can include a field for the hardware supplier as well as a checklist including items such as whether or not the manufacturer installs the frames and doors, and whether or not the manufacturer supplies hardware.

The shipping tab 860 typically includes fields for, but not limited to, to whom to ship the doors and frames, the job name, the ship-to address information, the target date for shipment, when the shipment is received, the number of frames and doors, a comment/remarks field and the like.

The change order information tab 850 allows the user to input any changes to the order.

Job Detail

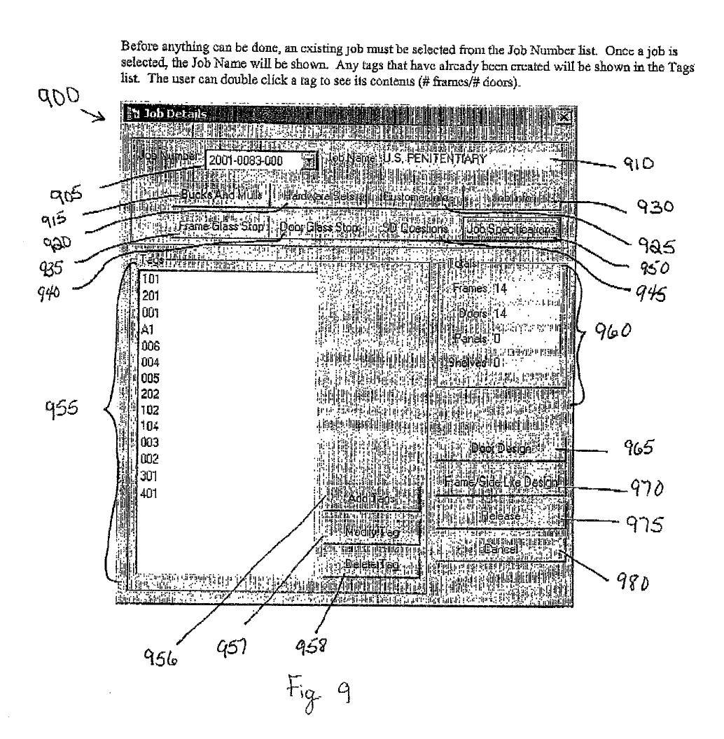

Referring again to FIG. 6, if the user presses the job detail button 615 from the main menu 600, the user is navigated to a series of screens related to the job details associated with that job. FIG. 9 illustrates an embodiment of a job details screen 900. The screen 900 typically includes a job number field 905 containing the job number and a job name field 910 with the associated job name. Several of the following figures illustrate screens to which can be navigated from the job details screen 900.

From the job detail screen 900, the user can begin to enter all of the necessary data for a job that is to be entered into the design process. Typically in a job, the user can define several tags, as shown in a tag field 955. Each tag has a contents, typically a number of doors and frames, each door and frame having a unique design and hardware set. A hollow metal frame has a buck profile and possibly a mullion profile. The term buck is understood by one skilled in the art to be the side profile of a hollow metal door frame and the term mull (mullion) is understood by one skilled in the art to be the profile of the hollow metal middle piece between two doors or two windows. Typically each door and frame also has an associated hardware set, such as locks, strike plates and the like. A single tag contains all of the bucks and mulls, and hardware set information. Since a job can have hundreds of doors and frames, it can be determined that there are certain repeats and therefore can be grouped into tags. FIG. 9 illustrates 14 tags in the tag field 955. In the simplest terms, 14 tags translates to 14 unique door and frame types in the job as shown in a totals field 960. It therefore makes an easier job for the user to identify those 14 different designs to 14 tags. It is understood that this example is simply illustrative. There can be any number of tags, and the contents of each tag can differ than as shown in FIG. 9, for example, the inclusion of panels and shelves.

### Bucks and Mulls

When the user presses a Bucks and Mulls button 915, the user is navigated to a series of screens that allows the user to enter the necessary data regarding the bucks and mulls of a job.

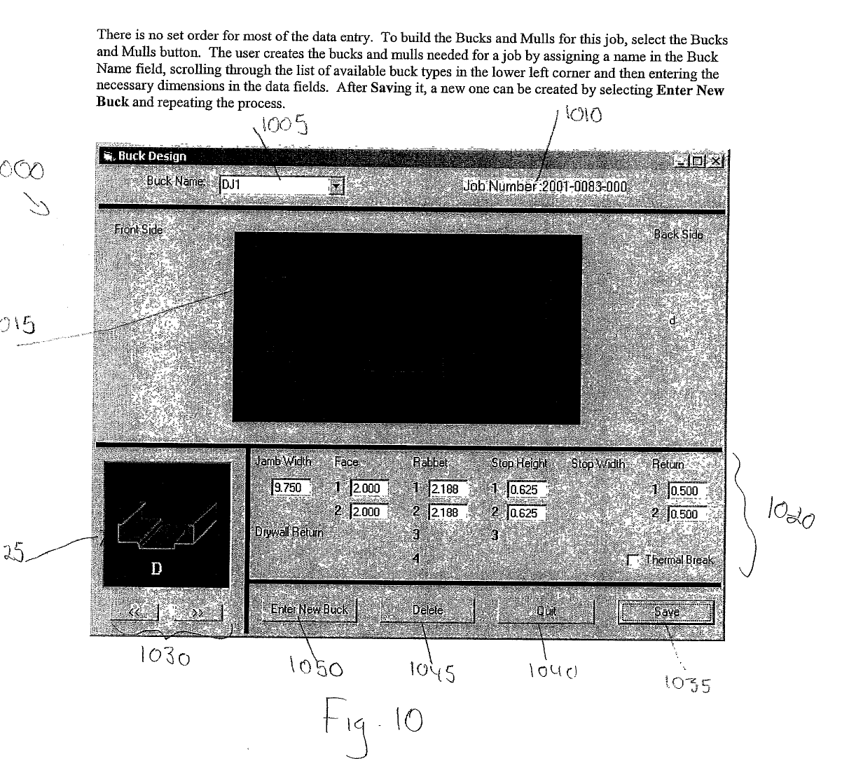

FIG. 10 illustrates an embodiment of a buck design screen 1000. The screen typically includes a buck name field 1005 where a user can enter a buck name. The buck name helps to uniquely name a buck associated with a job. Since there can be several different bucks in a job, it is necessary for the user to be able to differentiate among the different bucks. The screen 1000 also includes a job number field 1010. To aid the user in making decisions about the design of the bucks, the screen 1000 includes a buck display 1015, The user can scroll through a series of available buck types in a buck type display 1025 using scroll buttons 1030. When a desired buck is displayed in the buck display 1015, the user can make the necessary modifications to the dimensions of the buck using a series of dimension fields 1020. Such dimensions includes in the dimension fields can include but are not limited to jamb width, face, rabbet, stop height, stop width, return, drywall return, and whether or not a thermal break is present. The user can then press a save button 1035 to save this buck design. The user can also press a quit button 1040 to leave the buck design screen, press a delete button 1045 to delete the particular design or press a enter new buck button 1050 to create a new design.

By pressing the quit button 1040, the user is typically returned to the job details screen (900 in FIG. 9).

### Hardware Sets

When the user presses a Hardware Sets button 920, the user is navigated to a series of screens that allows the user to enter the necessary data regarding the hardware sets of a job.

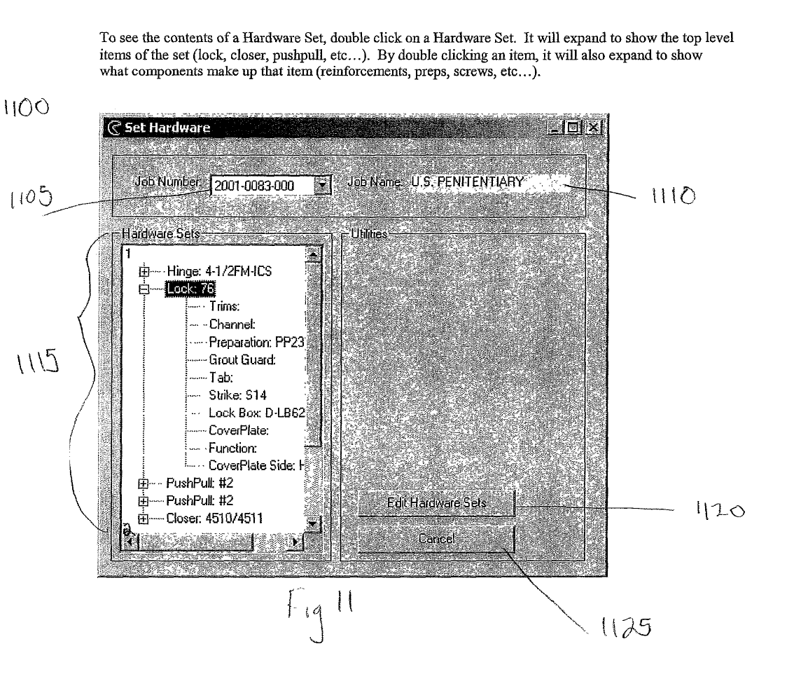

FIG. 11 illustrates an embodiment of a hardware set screen 1100. The screen 1100 typically includes a job number field 1105 and a job name field 1110.

The screen 1100 also includes a hardware sets field 1115. Here several hardware sets are listed. As described above, each tag has an associated hardware set. The number of hardware sets and tags are not necessarily the same. There may be more or less common hardware sets to the tags. FIG. 11 illustrates one hardware set labeled, “1”, that has been expanded to show its contents. Hardware set 1 includes a hinge, lock, two pushpulls and a closer. FIG. 11 also illustrates that each piece of hardware in the hardware set can be further expanded.

Hardware sets can become complicated because there are several manufacturers who each offer several different hardware component possibilities. The user can press an edit hardware sets button 1120 to modify details about the hardware sets. The user typically highlights the desired hardware set in the hardware sets field 1115 and then presses the edit hardware sets button 1120. If the user decides to create a new hardware set, the user does not highlight an existing set and simply presses the edit hardware sets button 1120. Alternatively, the user can press the cancel button 1125 to return to the job detail screen (900 in FIG. 9).

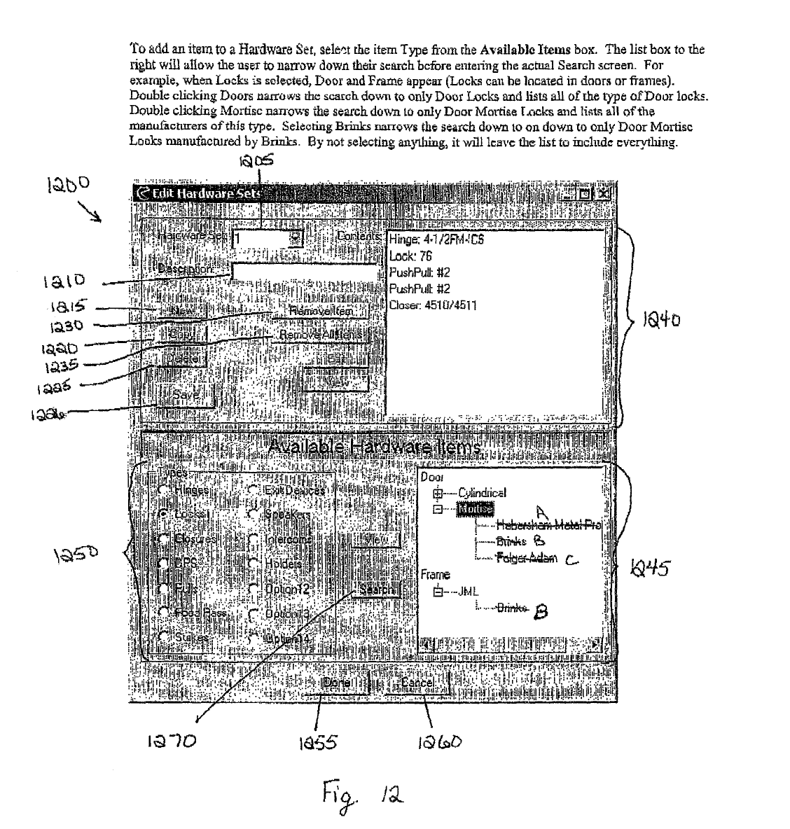

FIG. 12 illustrates an embodiment of an edit hardware sets screen 1200. The screen 1200 is used to edit an existing hardware set or create a new set. The screen 1200 typically includes a hardware set name field 1205 and a description field 1210. The contents of the hardware set of interest is displayed in a contents field 1240. The user can create a new hardware set by pressing a new button 1215, copy an existing set by pressing a copy button 1220, delete an existing set by pressing a delete button 1225 or save a new set by pressing a save button 1226. Items within the hardware set can be removed by highlighting an item in the contents field 1240 and pressing a remove item button 1230. All items in the contents field 1240 can be removed by pressing a remove all items button 1235. When the user has completed adding or modifying a set, the user can press a done button 1255 to return to the hardware set screen (1100 in FIG. 11). Alternatively, the user can cancel out of the screen 1200 by pressing a cancel button 1260.

To add an item to the hardware set, the user selects the item type from one of the fields in a types field 1250. A list box 1245 aids a user in narrowing down the search criteria before entering a search screen to choose a hardware item. For example, FIG. 12 illustrates that the user desires to add a lock. The user clicks the lock field in the types field 1250. When the locks field is chosen, lock types appear in the list box 1245. Here locks are listed for a door and for a frame. Under the door, two lock types are listed: cylindrical and mortise. Further, the mortise choice has been expanded to display three possible manufacturers who can provide the mortise locks for doors: A, B and C. The frame listing shows JML (jamb mounted locks), with one manufacturer, B. The user can choose a specific manufacturer for a specific item by highlighting that manufacturer. In this way the search can be reduced to only items of the selected type by this manufacturer. but if the user does not highlight any of the specific manufacturers, then the user can have a broader search. If the user wants to perform the search, the user can press a search button 1270 that navigates the user to a hardware search screen as discussed below.

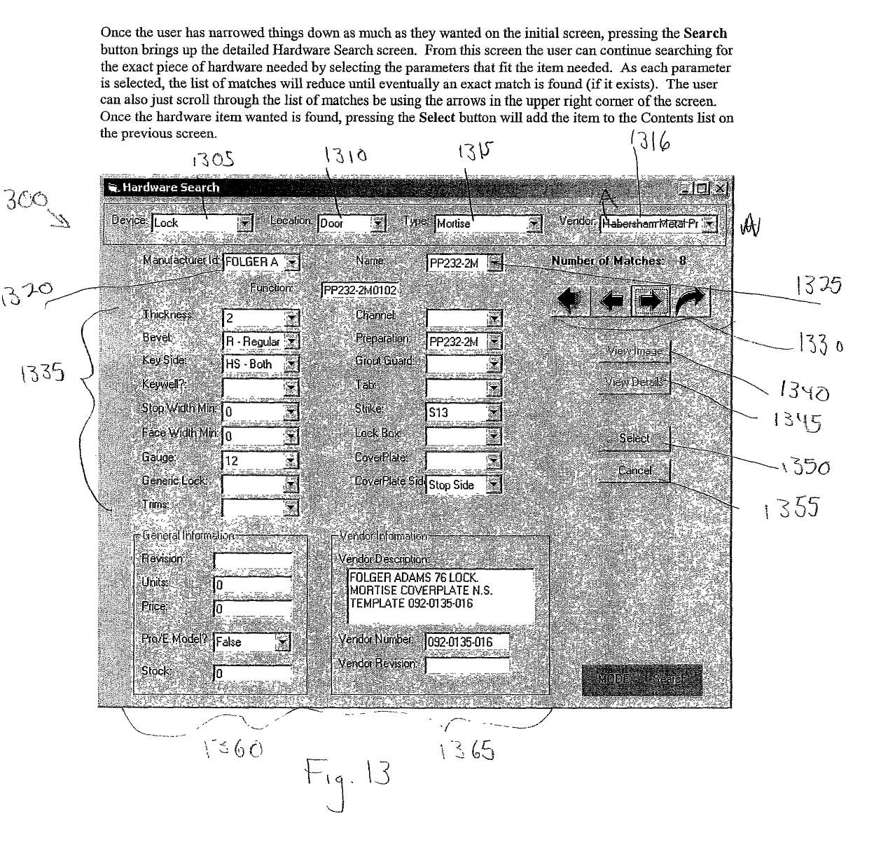

FIG. 13 illustrates an embodiment of a hardware search screen 1300. The screen 1300 typically includes a device field 1305, a location of the device field 1310, a type field 1315 and a vendor field 1316. The screen also includes a manufacturer ID field 1320 as well as a name field 1325 for the name of the hardware item. A series of scroll buttons 1330 allows the user to scroll through the different hardware items. FIG. 13 illustrates that 8 items match the criteria for the mortise door lock by vendor A. The user can adjust fields in the parameter section 1335 in order to further narrow the search. Once items are narrowed, the user can view an image of the item by pressing a view image button 1340. The user can also view details about the item shown in a field by selecting the item and pressing the view details button 1345. The screen 1300 also includes a general information section 1360 about the item as well as a vendor information section 1365. Once the user has identified the desired hardware item, the user can press a select button 1350 to choose the item. Alternatively, the user can cancel out of the screen 1300 by pressing a cancel button 1355. The user is returned to the edit hardware sets screen (1200 in FIG. 12) and then can return to the hardware set screen (1100 in FIG. 11).

### Frame Glass Stop

Referring back to FIG. 9, the user can create frame glass stop information for a job by pressing the frame glass stop button 935 that navigates the user to a frame glass stop screen.

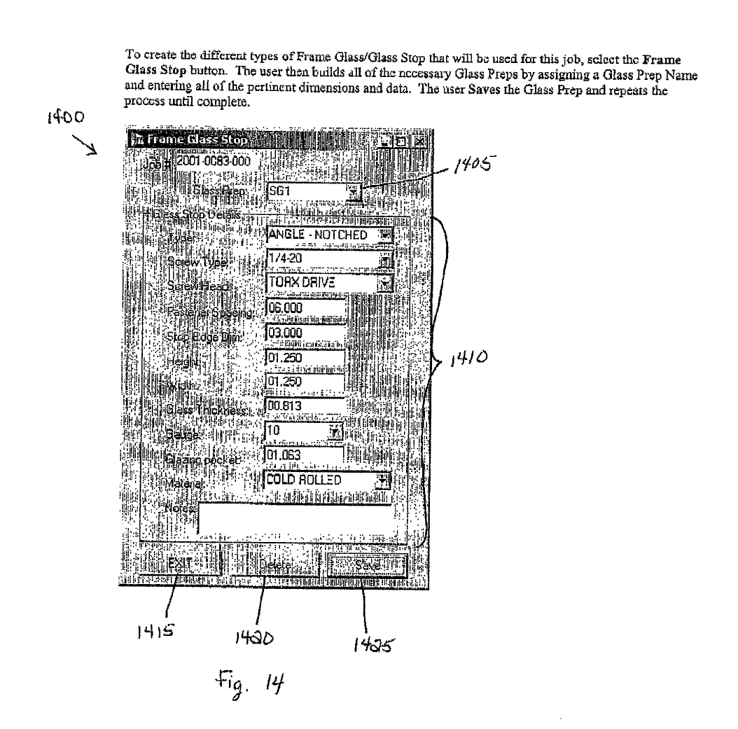

FIG. 14 illustrates an embodiment of a frame glass stop screen 1400. the screen 1400 includes a glass prep field 1405 and a glass stop details section 1410 that includes but is not limited to glass stop parameters such as type, screw type, screw head, fastener spacing, stop edge dimension, height, width, glass thickness, gauge, glazing pocket, material and notes. Changes can be saved by pressing the save button 1425. A glass prep 1405 can be deleted by pressing the delete button 1420. The user can cancel from the screen 1400 and return to the job details screen (900 in FIG. 9) by pressing the exit button 1415.

### Door Glass Stop

Referring back to FIG. 9, the user can create door glass stop information for a job by pressing the door glass stop button 940 that navigates the user to a door glass stop screen.

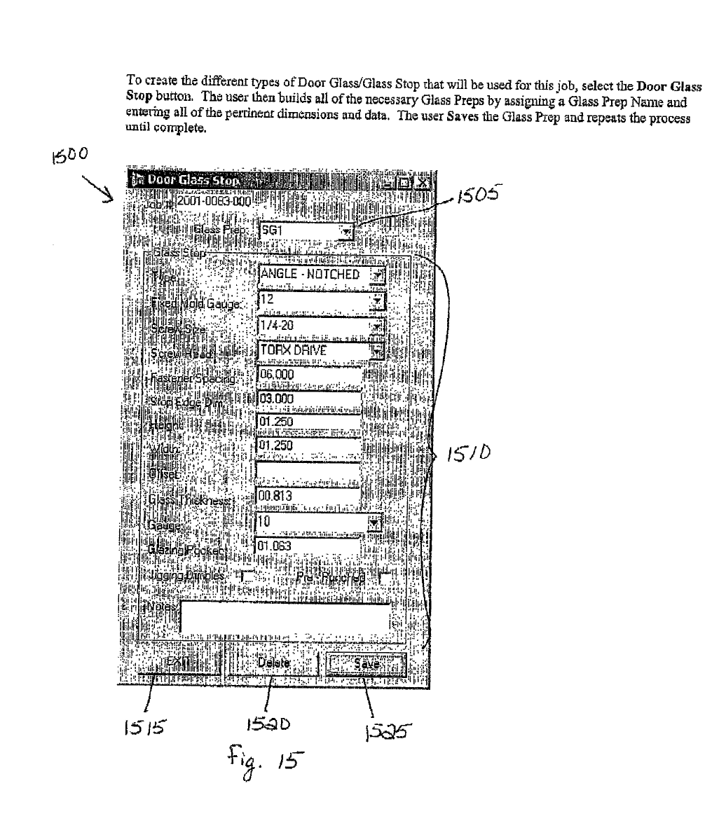

FIG. 15 illustrates an embodiment of a door glass stop screen 1500. The screen 1500 includes a glass prep field 1505 and a glass stop details section 1510 that includes but is not limited to glass stop parameters such as type, screw type, screw head, fastener spacing, stop edge dimension, height, width, glass thickness, gauge, glazing pocket, material and notes. Changes can be saved by pressing the save button 1525. A glass prep 1505 can be deleted by pressing the delete button 1520. The user can cancel from the screen 1500 and return to the job details screen (900 in FIG. 9) by pressing the exit button 1515.

### Shop Drawing Questions

Referring back to FIG. 9, the user can enter shop drawing questions for a job by pressing the sd questions button 945 that navigates the user to a shop drawing questions screen.

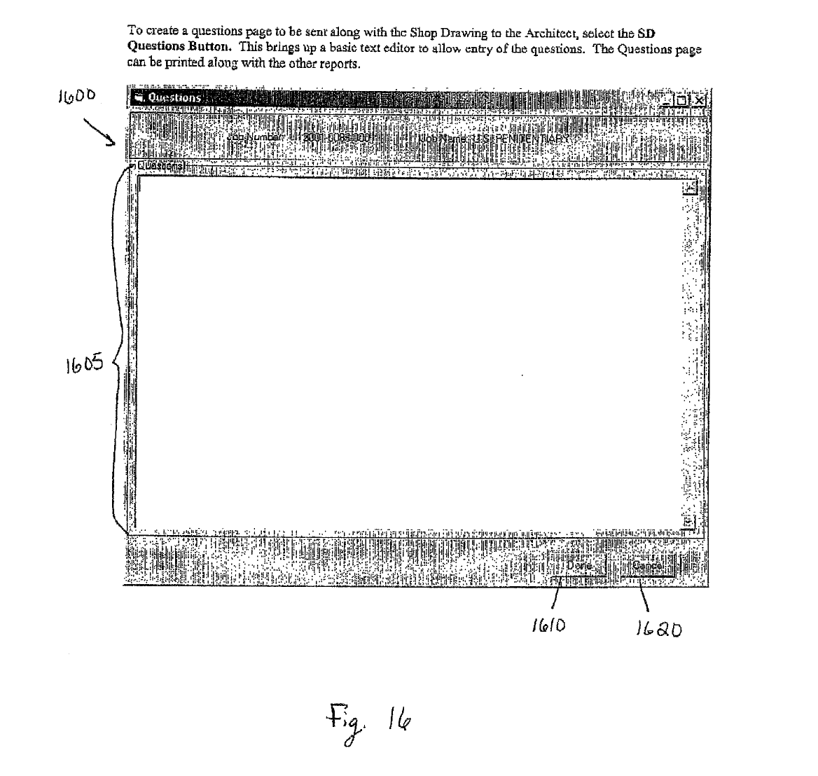

FIG. 16 illustrates an embodiment of a shop drawing questions screen 1600. The screen 1600 includes a questions section 1605 where the user can enter questions to be printed on a report (discussed later). Changes can be saved by pressing the done button 1610. The user can cancel from the screen 1600 and return to the job details screen (900 in FIG. 9) by pressing the exit button 1620.

### Master Job Specifications

Referring back to FIG. 9, the user can enter master job specifications for a job by pressing the job specifications button 950 that navigates the user to a master job specifications screen.

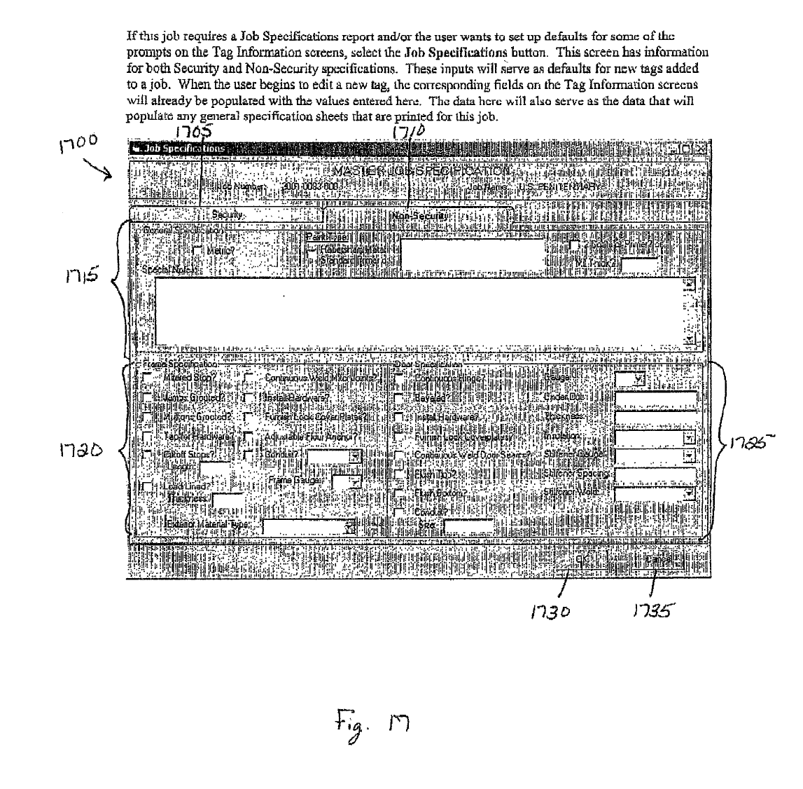

FIG. 17 illustrates an embodiment of a master job specifications screen 1700. The screen 1700 includes a security tab 1705 and a non-security tab 1710 where the user selects which type of specification is to be entered as well as a general specification section 1715 that includes but is not limited to paint type information, primer information, whether or not the job is metric and special notes. The screen 1700 also includes a frame specification section 1720 that contains several fields that can be chosen to apply to frames for this job; the fields include but are not limited to mitered stop, jambs grouted, mullions grouted, tap for hardware, cutoff stops (including a field for cutoff stop length), lead lined (including a field for thickness), continuous weld miter joints, install hardware, furnish lock cover plates, adjustable floor anchor, conduit (including a field for size), gauge and exterior material type. The screen 1700 further includes a door specification section 1725 that contains several fields that can be chosen to apply to doors for this job; the fields include but are not limited to continuous hinge, beveled, install hardware, furnish lock cover plates, continuous weld door seams, flush top, flush bottom, conduit (including a field for size), gauge, under cut, thickness, insulation, stiffener gauge, stiffener spacing and stiffener weld. Changes can be saved by pressing the ok button 1730. The user can cancel from the screen 1700 and return to the job details screen (900 in FIG. 9) by pressing the cancel button 1735.

### Add Tags

Referring again to FIG. 9, the user can add tags to a job by pressing an add tags button 956 that navigates the user to an add tags screen.

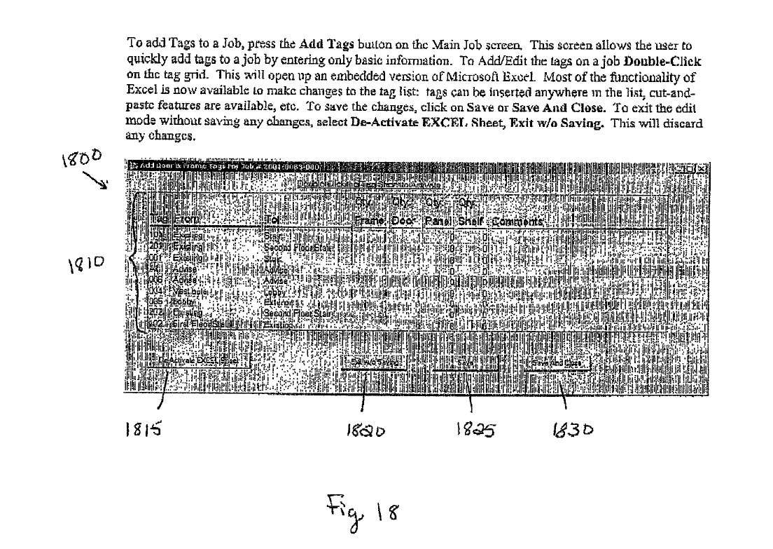

FIG. 18 illustrates an embodiment of an add tags screen 1800. The screen includes a tag field 1810 that includes but is not limited to tag information such as the tag name, “to” and “from” fields that indicate the location changes to which the tags correspond, the number of frames, doors panels, shelves and the like, as well as a remark field. The user can modify an existing tag or a new tag by double clicking on the grid 1810. Changes can be saved by pressing the save 1825 or save and close 1830 button. Alternatively, the user can cancel from the screen 1800 by pressing a exit button 1820. The screen 1800 allows the user to quickly add tags to a job by entering only basic information and changing locations. To modify the tag the user enters a tag detail screen.

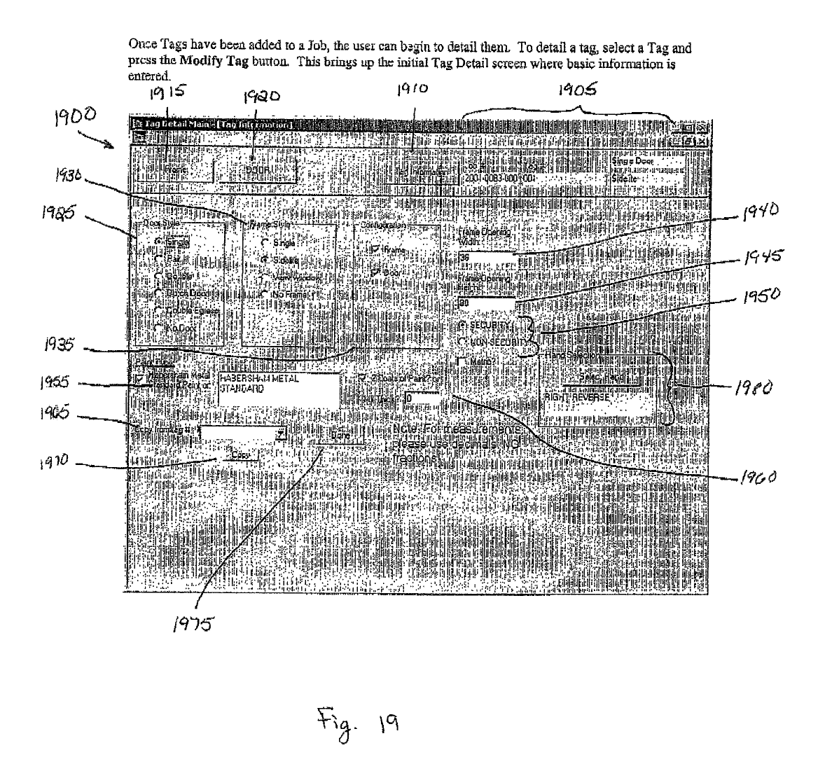

FIG. 19 illustrates an embodiment of a tag detail screen 1900. The screen 1900 includes a general information section 1905 including the job number, the tag number, and the door type and whether or not it has a window or sidelite. A tag information button 1910 defaults to the screen 1900 when the user presses it. A frame button 1915 navigates the user to a frame information screen (discussed below) and a door button 1920 navigates the user to a door information screen (discussed below).

The tag details on the screen 1900 include a door style section 1925, which can include door styles like but not limited to single, pair, double dutch, double egress and no door. The screen 1900 also includes a frame style section 1930, which includes frames styles like, but not limited to, single, sidelite, view window and no frame. The screen 1900 further includes a configuration section 1935 that indicates the presence or absence of doors and frames in the tag.

The screen 1900 also includes a frame opening height field 1945, a frame opening width field 1940 and a section 1950 to indicate whether or not the tag is for security or non-security doors and frames, whether or not the tag is metric, and a hand field 1980 (i.e., what side the door opens and whether it opens in or out). The user can press a select hand button to navigate to a select hand screen (discussed later). The screen can include a paint type field 1955 and a field 1960 to indicate whether or not two coats of paint are to be used as well as the mil thickness. The screen 1900 can further include a copy field 1965 if the user wants to indicate a tag that the user wants to copy, and a corresponding copy button 1970 to execute the copy. When the user is done with the tag information screen 1900, the user can press a done button 1975 to exit the screen.

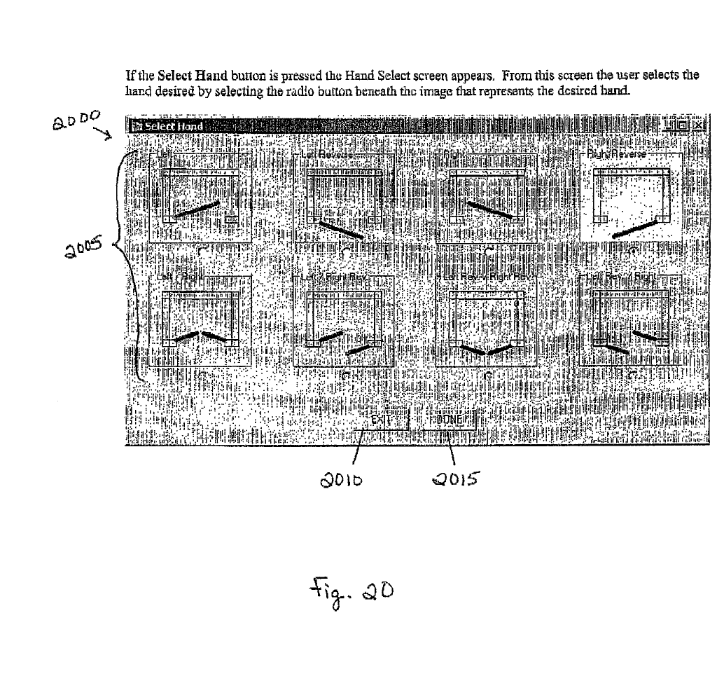

FIG. 20 illustrates an embodiment of a hand select screen 2000. Using the screen 2000, a user can select the handedness of the door, by selecting the image that represents the desired hand. Once the correct handedness image is selected 2005, the user can press the done button 2015 to save the selection and return to the tag details screen FIG. 19. Alternatively, the user can press the exit button 2010 to cancel and return to the tag details screen FIG. 19.

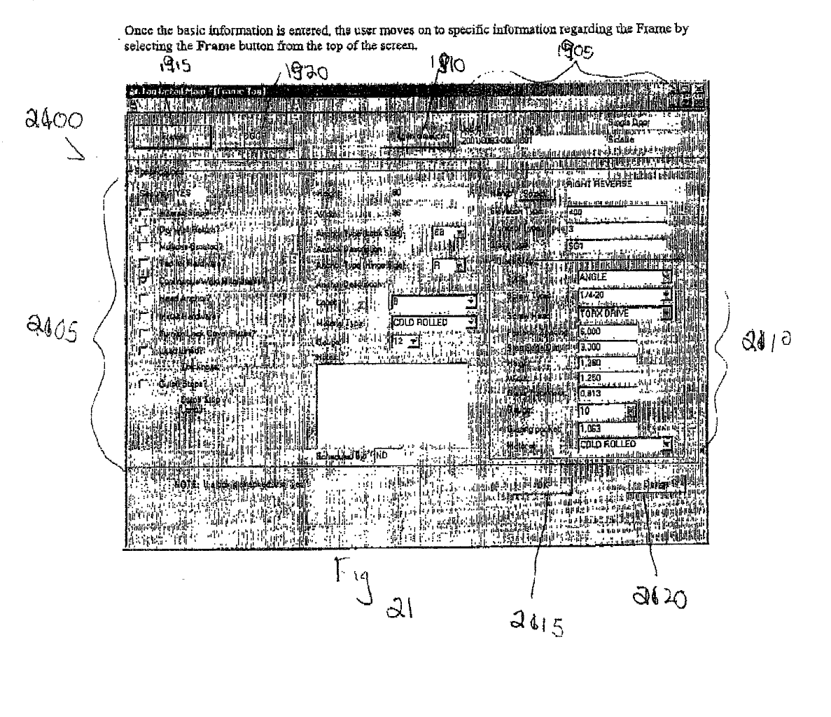

As indicated above, the user can also press the frame button 1915 to navigate to a frame information screen. FIG. 21 illustrates an embodiment of a frame information screen 2100. The upper section of the screen 2100 remains the same as shown in FIG. 19. That is, the screen 2100 includes a general information section 1905 including the job number, the tag number, and the door type and whether or not it has a window or sidelite. The tag information button 1910 defaults to the tag detail screen (1900 in FIG. 19) when the user presses it. A frame button 1915 navigates the user to the frame information screen 2100 and the door button 1920 navigates the user to a door information screen (discussed below).

The screen 2100 further includes a specifications section 2105 that contains several fields that can be chosen to include on the frame, the fields including but not limited to security, mitered stop, dry wall return, mullions grouted, tap for hardware, continuous weld miter joints, head anchor, install hardware, furnish lock cover plates, lead lined (including a field for thickness) and cutoff stops (including a field for cutoff stop length). Further fields in the specifications section 2105 can include but are not limited to frame height and width, anchor type (lock side) and description, anchor type (hinge side) and description, label, material type, gauge and any noted associated with the frame, the hand of the frame, elevation type, architect type and glass type.

The screen 2100 can also include a glass stop section 2110 that can include fields including but not limited to type, screw type, screw head, fastener spacing, stop edge dimension, height, width, glass thickness, gauge, glazing pocket and material.

One the user has complete entering data into the fields, the user can press an ok button 2115 to accept and exit the screen or the user can press a design button 2120 to create the actual design/layout of the frame.

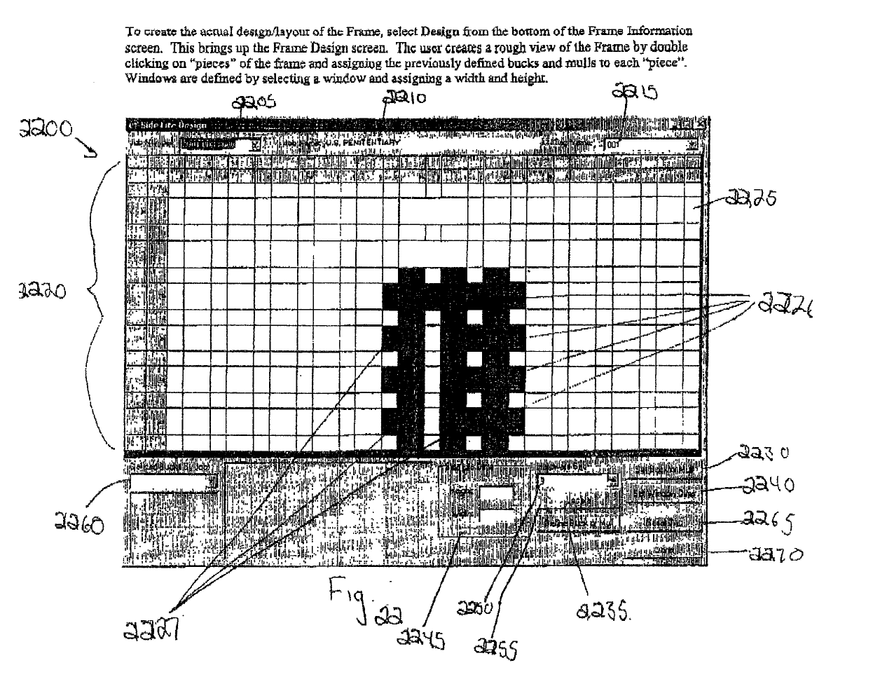

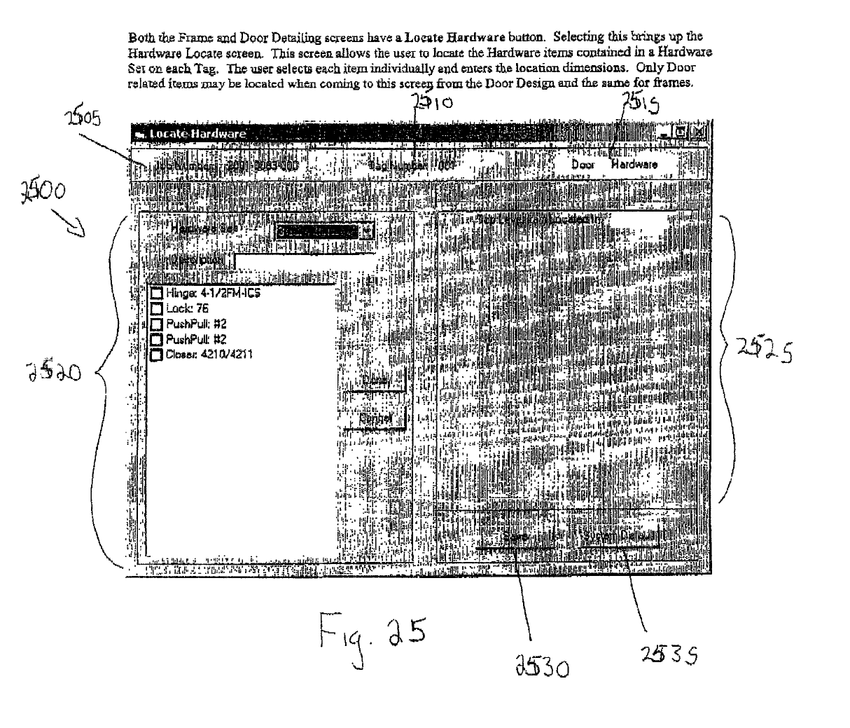

FIG. 22 illustrates an embodiment of a frame design grid screen 2200. The screen 2200 includes a job number field 2205, a job name field 2210 and a tag name field 2215. The screen 2200 further includes a data grid 2220 having a plurality of cells 2225. The user can create a view of the frame by clicking on individual cells 2225, which comprise the individual pieces of the frame. Previously designed bucks and mulls (see FIG. 10) can be assigned to each of the cells 2225. Windows can be defined (e.g., sidelites) by also clicking on individual cells 2225. Bucks and mulls can be set by selecting the desired buck from the defined bucks by job 2260 field and pressing a set buck or mull button. The user can also define bucks and mulls by pressing a define buck and mull button 2235. Window dimensions can be set by entering dimensions into the sidelite dimension section 2245 having fields for the height and width of the sidelite and pressing a set window dimensions button 2240. The screen 2200 can further include a hardware set field 2250 and a locate hardware set button 2255 (see further discussion below with respect to FIG. 25). The screen 2200 can also include a field 2260 that defines the bucks created for this job. The user has the option to reset the tag associated with the frame by pressing a rest tag button 2265. When the user is complete with the frame design, the user can press a done button 2270.

In an implementation, the data grid 2220 can be a modified Microsoft Excel spreadsheet. FIG. 22 illustrates a particular door frame having a sidelite. It is understood that the data grid 2220 can be used to design several other types of frames. In the frame shown, several cells 2226 are used to define a sidelite and several other cells 2227 are used to define the frame itself.

Referring again to FIGS. 19 and 21, the screens 1900, 2100 further include a door button 1920. When the user presses the door button 1920, the user is navigated to a tag detail screen for door design.

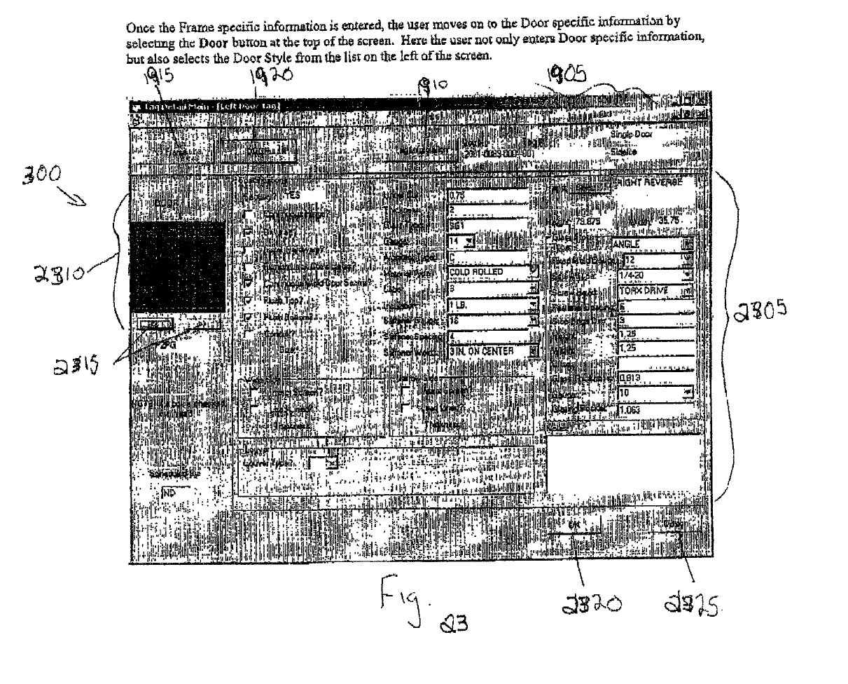

FIG. 23 illustrates an embodiment of a door information screen 2300. The upper section of the screen 2300 remains the same as shown in FIG. 19. That is, the screen 2300 includes a general information section 1905 including the job number, the tag number, and the door type and whether or not it has a window or sidelite. The tag information button 1910 defaults to the tag detail screen (1900 in FIG. 19) when the user presses it. A frame button 1915 navigates the user to the frame information screen (2100 in FIG. 21) and the door button 1920 navigates the user to a door information screen 2300.

The screen 2300 further includes a specification section 2305 that contains several fields that can be chosen to include with the door, the fields including but not limited to security, continuous hinge, beveled, install hardware, furnish lock cover plates, continuous weld door seams, flush top, flush bottom, conduit (including size), whether or not the wide and narrow sides of the door have an insect screen and are lead lined, and whether or not the door is louver type. Other fields include the undercut size, thickness, glass type, gauge, architect type, material type, label, insulation, stiffener gauge, stiffener spacing, stiffener weld, and the hand of the door.

Referring again to FIG. 23, further fields in the specification section 2305 include the height, width and information about the glass stop including, but not limited to type, fixed mold gauge, screw type, screw head, fastener spacing, stop edge dimension, height, width, offset, glass thickness, gauge and glazing pocket. The user can initially choose the basic door style 2310 using scroll buttons 2315. Once the user is complete, the user can press an ok button 2320. The user can also press a design button 2325 to navigate to a design screen.

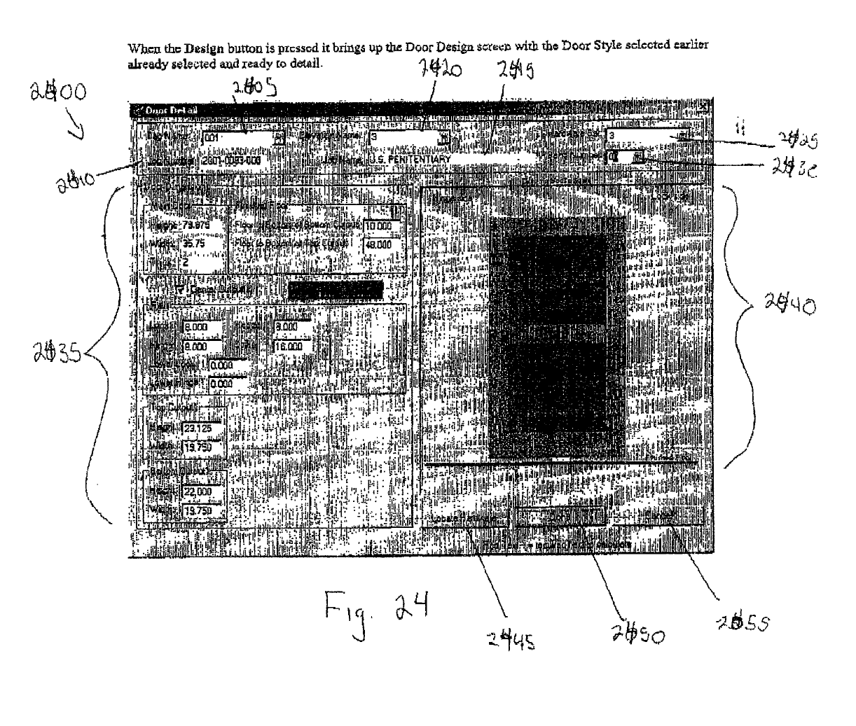

FIG. 24 illustrates an embodiment of a door design screen 2400. The screen 2400 includes a tag name field 2405, a job number field 2410, a job name field 2415, an elevation name field 2420, a hardware set field 2425 and a bend number field 2430.

The screen 2400 further includes a display section 2440 that displays the basic door style chosen in the door information screen (2300 in FIG. 23). The screen 2400 also includes a door dimensions section 2435. The door dimensions section 2435 typically includes fields for height, width and thickness of the door as well as the cut from the floor to the bottom of the bottom cutout of the door and the floor to bottom of the top cutout if any exist. These measurements are typical in hollow metal manufacturing. The section 2435 also can include a field indicating whether or not the cutout should be centered in the door. A verify/calculate button is also included in the section 2435 to calculate the correct door dimensions based on user input. The section 2435 further includes various fields for rails including but not limited to fields for lock, header, hinge, strike, lower lock and lower hinge. The section 2435 further includes fields for the height and width of the cutouts. The fields displayed vary based on the style of door selected in section 2300 in FIG. 23.

When the user completes the design, the user can press a done button 2450 to exit the door design screen 2400 or press a cancel button 2455 to leave the screen altogether. The user may also want to know specifics about the hardware set indicated in the hardware field 2425. The user can press a locate hardware button 2445 to navigate to a locate hardware screen.

FIG. 25 illustrates an embodiment of a locate hardware screen 2500. As described immediately above with respect to FIG. 24, the user may want to locate and look at or change the hardware set. The user can also navigate to this screen 2500 from the frame design data grid screen (see FIG. 2200).

The screen 2500 typically includes a job number field 2505, a tag number field 2510 indicating the tag that corresponds to this hardware set and a frame/door hardware indication screen 2515. The indication field 2515 in FIG. 25 displays “door hardware”. If the screen 2500 were navigated from the frame design data grid screen (see FIG. 22), the indication field 2515 would display “frame hardware”. Typically, only door related items may be located when navigating to this screen 2500 from the door design screen (2400 in FIG. 24) and only frame related items may be located when navigating to this screen 2500 from the frame design data grid screen (2200 in FIG. 22).

The screen 2500 also includes a hardware display section 2520. The section 2520 includes a hardware set field and a description field. The section 2520 also includes a listing display of the hardware components used in the door or frame. The section 2520 also includes done button and a cancel button to leave the screen 2500. The screen 2500 further includes a location display section 2525 that displays the location of hardware items within the hardware set on each tag.

The user can save any changes made by pressing a save button 2530 or the user can choose default hardware (if applicable) by pressing a system default button 2535.

Release

Once a job has been detailed, it is ready to be released. Referring again to FIG. 6, if the user presses the release 620 button from the main menu 600, the user is navigated to a series of screens related to releasing the job for processing by the design process.

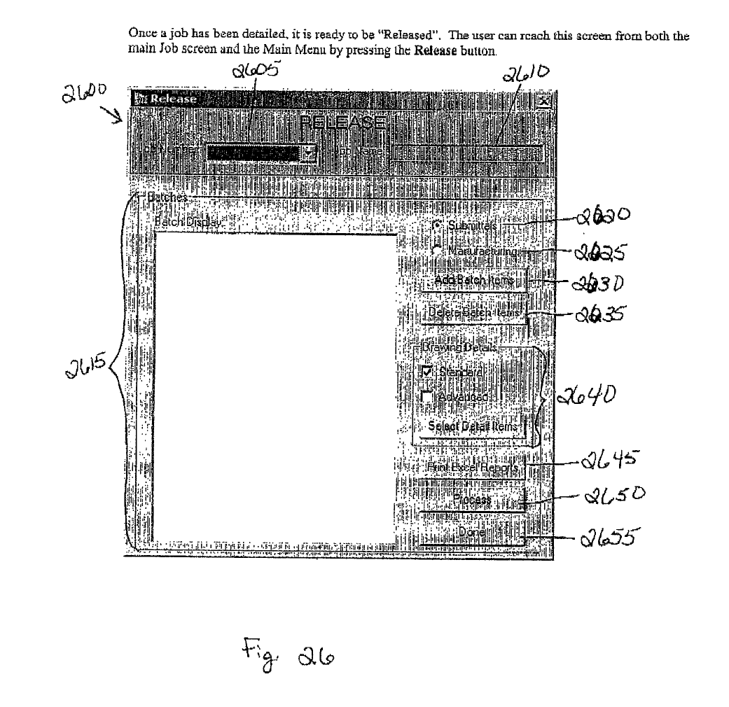

FIG. 26 illustrates an embodiment of a release screen 2600. The screen 2600 includes a job number field 2605 and a job name field 2610. The screen 2600 also includes a batch display 2615. When the screen 2600 is initially launched any previously created batch is displayed. A typical batch includes a number of tags that were previously created. The screen 2600 also includes a submittal field 2620 and a manufacturing field 2625 that indicate the type of batch that is to be processed. Typically, if the submittal field 2620 is chosen, drawings and output with little detail is generated, typically for review purposes. If the manufacturing field 2625 is chosen, then the output is much more detailed and is used more extensively in the output process. If the user wants to add, modify or delete items from the batch, the user can navigate to appropriate screens by pressing an add batch items button 2630 or a delete batch items button 2635. The user can choose details about the drawings in a drawing details section that can include a choice between standard and advanced drawings as well as specific details about the drawings. The user can also generate reports (usually in Excel format) by pressing the reports button 2645. Reports are typically manufacturing schedules, drawing cover sheets, tag listings, etc. Once the user has decided on the batch the user can either process the batch by pressing a process button 2650 or leave the screen 2600 by pressing a done button 2656.

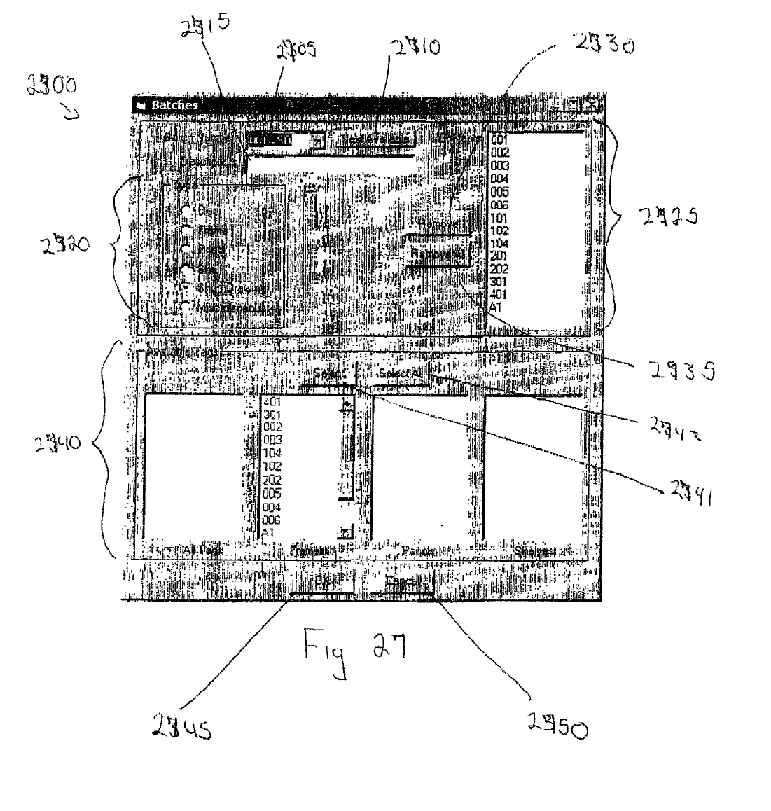

As described above, the user can add batch items by pressing the add batch items button 2630. FIG. 27 illustrates an embodiment of a batch creation screen 2700. The screen 2700 allows the creation and modification of batches. The screen 2700 includes a batch number field 2705, a button 2710 to choose the next available tag number and a description field 2715. The screen 2700 includes a type section 2720 that has fields indicating whether the batch type is a door, frame, panel, shelf, shop drawing miscellaneous and the like. A contents field 2725 indicates the tags that are included in the batch. A remove button 2730 and a remove all button 2735 can be used to remove some or all of the tags from the batch. An available tags section 2740 gives the user options to pick and choose from available tags that were previously created. The section 2740 includes fields for all tags, frames, panels, shelves and the like. The user can select some or all of the tags by pressing a select button 2741 or a select all button 2742. When the user is complete, the user can press an ok button 2745 or a cancel button 2750 to discard the changes.

Hardware

Referring again to FIG. 6, if the user presses the hardware button 625 from the main menu 600, the user is navigated to a series of screens related to the hardware associated with the job. The user is typically navigated to a screen similar to the hardware search screen (1300 in FIG. 13). The screen to which the user is navigated is similar to the hardware search screen 1300, but the user has access to buttons for editing, deleting, adding or otherwise modifying hardware items.

Referring still to FIG. 13, the user has access to a device of type prep. When adding/editing a preparation item, an additional feature, assign cuts, is enabled (e.g., the appearance of an additional button). The assign cuts button (not shown) allows the user to be navigated to a prep cuts screen.

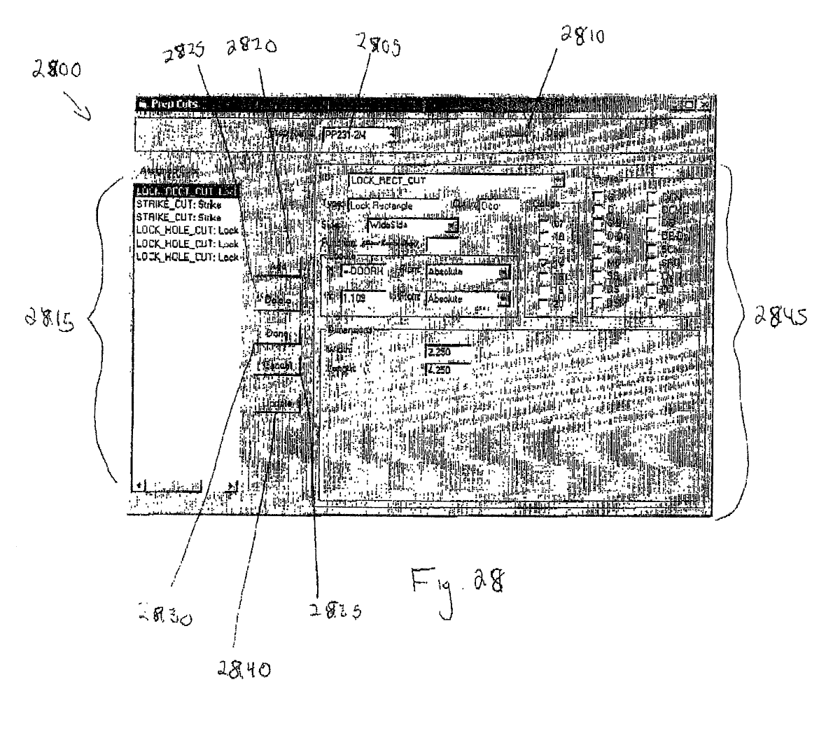

FIG. 28 illustrates an embodiment of a prep cuts screen 2800. The screen 2800 includes a prep name field 2805 and a location field 2810. The screen 2800 also includes an assigned cuts display 2815 that includes the assigned cut preparations that have already been created. The user can add a new cut preparation by pressing an add button 2820 and delete a cut preparation by pressing a delete button 2825. The user can also press a done button 2830 when the user is complete. The user can also discard any changed by pressing a cancel button 2835. Finally the user can save any changes to an existing cut preparation by pressing an update button 2840.

The screen 2800 also includes a prep details section 2845. The section 2845 includes fields for the identification of the cut, the type of cut, the cut in, the side for the cut, the location of the cut including X and Y machine location, the gauge of the material being cut, the profile the cut will work in (frame cuts), including but not limited to profiles such as S, D, Sdry, Ddry, MS, MD, SS, DS, DSM, DCM, DCMO, DE, DE-Dry, SCM, SRO, SM, CO and all. The details section 2845 also includes fields for dimensions such as width and length or any other dimensions needed for the specified type of cut.

The screen 2800 is particularly helpful especially in situations in which hardware sets are not initially known. Once hardware sets are chosen, the screen 2800 can be used to indicate where cuts and other preparations are going to be made in the hollow metal.

The previous embodiments of the user interface screens described above are typically located on the clients machines. As described above, the batches are subsequently sent on a network to a server where the design process resides.

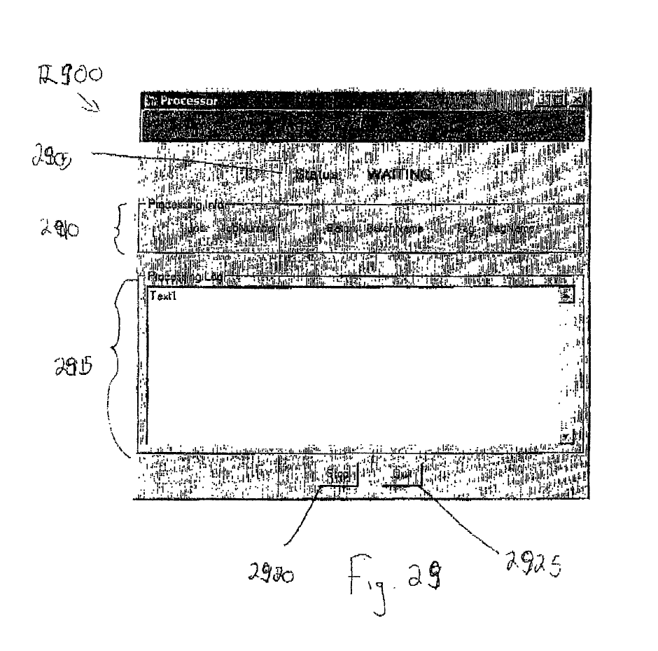

FIG. 29 illustrates an embodiment of a server processor status screen 2900. The screen 2900 includes a status field 2905 that indicated the status of the batch or batches being processed. The screen 2900 also includes a processing information section 2910 that includes fields for the job number, batch name and specific tag under processing. A processing log display 2915 is also included. The log display indicates those items that have been processed, including any errors and other pertinent information. As described above, the batches are processed by the batch information being piped to the server. Each tag in the batch is processed by the design process which generates a corresponding output.

The user interface embodiments allow the user flexibility in the design process. The project manager can coordinate with other people involved with the project such as the architect. By pulling up a job number, individual tags can be reviewed. IF a tag is entered incorrectly or if other information needs to be modified, the user can universally change that information. For example, if an incorrect buck or mull is entered, the user can change the buck or mull within the tag, for example, from the Buck design screen (see FIG. 10). In this way, the user interface embodiments act as a central location from which changes can be easily made without having to be concerned about the complexity of the CAD design process.

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in a high level procedural or object-oriented programming language, or in assembly or machine language, which can be compiled or interpreted. Suitable processors include, by way of example, both general and special purpose microprocessors. generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

Therefore, the foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A manufacturing control system, comprising:
at least one server adapted to process specification data;
at least one client connected to the server, the client having specification data;
a design process residing on the server;
a user interface residing on the client; and
a translation process connected between the client and the server.

2. The system as claimed in claim 1 further comprising at least one information database.

3. The system as claimed in claim 2, wherein the informational database includes hollow metal manufacturing data.

4. The system as claimed in claim 1, wherein the specification input user interface includes fields for hollow metal manufacturing input.

5. The system as claimed in claim 1, wherein the system is connected to a network.

6. The system as claimed in claim 1 further comprising manufacturing machines adapted to receive processed specification data from the server.

7. A manufacturing control method, comprising:
defining an article of manufacture on a user interface;
creating data files from the user interface;
creating batch files from the data files;
transferring the data files to a design process;
processing the batch files; and
generating output.

8. The method as claimed in claim 7, wherein the article of manufacture relates to hollow metal.

9. The method as claimed in claim 7, wherein the data files are tags.

10. The method as claimed in claim 7, wherein the batch files are a collection of tags.

11. The method as claimed in claim 7, wherein the design process is computer aided design software.

12. The method as claimed in claim 7, wherein the output includes drawings.

13. The method as claimed in claim 7, wherein the output includes data files.

14. The method as claimed in claim 7, wherein the output includes numerical control code.

15. The method as claimed in claim 7, wherein the files are transferred to a server over a network.

16. The method as claimed in claim 15, wherein the files are processed by a computer aided design process on the server.

17. A user interface, comprising:
a customer information screen;
a job information screen;
a job details screen;
data screens adapted to receive manufacturing specification data; and
an operational screen adapted to allow a user to navigate between the customer information, job information, job details and data screens.

18. The user interface as claimed in claim 17, wherein the job information screen comprises:
a scheduling screen;
a shipping information screen;
a change order information screen; and
a pricing information screen, wherein the scheduling, shipping, change order information and pricing information screens are adapted to be navigated from the job information screen.

19. The user interface as claimed in claim 17, wherein the data screens include a buck and mull design screen.

20. The user interface as claimed in claim 17, wherein the data screens include a door design screen.

21. The user interface as claimed in claim 17, wherein the data screens include a frame design screen.

22. The user interface as claimed in claim 17, wherein the data screens include a hardware screen.

23. The user interface as claimed in claim 17, wherein the data screens include a tag design screen, wherein the tag defines a article of manufacture design.

24. A method of interfacing to computer aided design software, comprising:
generating a user interface adapted to receive manufacturing specifications;
connecting the user interface to a translation process;
using the translation process to adapt the manufacturing specifications to data readable by a computer aided design process;
connecting the translation process to a pipe adapted to interface with the computer aided design process; and
using the computer aided design process to generate output based on the translated manufacturing specifications data.

25. A computer program residing on a computer readable medium comprising instructions for causing a computer to:
generate a user interface adapted to receive manufacturing specifications;
connect the user interface to a translation process;
use the translation process to adapt the manufacturing specifications to data readable by a computer aided design process;
connect the translation process to a pipe adapted to interface with the computer aided design process; and
use the computer aided design process to generate output based on the translated manufacturing specifications data.

26. A method of generating CAD data, comprising:
entering manufacturing specifications data into a user interface;
organizing the manufacturing specifications data to tags;
organizing the tags into batch files adapted to be translated into CAD usable data; and
preparing the batches to be transferred to a translation process.

27. A method of implementing a CAD process, comprising:
receiving manufacturing specification data organized into batches into a translation process residing on a server;
using the translation process to translate the manufacturing specification data to CAD usable data;
inputting the CAD usable data into a CAD process; and
using the CAD process to generate output based on the CAD usable data.

28. A process for developing hollow metal products, the process comprising;
a user interface adapted to receive specifications for the products;
a design process connected to the user interface, the design process adapted to receive data from the user interface; and
a punch machine process connected to the design process, the punch machine process adapted to control hollow metal manufacturing machines that form hollow metal into the hollow metal products.
